(19) United States
(12) Patent Application Publication
(10) Pub. No.: US 2020/0333795 A1
(43) Pub. Date: Oct. 22, 2020

(54) METHOD AND APPARATUS FOR CONTROLLING MOVEMENT OF REAL OBJECT USING INTELLIGENT AGENT TRAINED IN VIRTUAL ENVIRONMENT

(71) Applicant: Electronics and Telecommunications Research Institute, Daejeon (KR)

(72) Inventor: Soo Young JANG, Daejeon (KR)

(73) Assignee: Electronics and Telecommunications Research Institute, Daejeon (KR)

(21) Appl. No.: 16/841,057

(22) Filed: Apr. 6, 2020

(30) Foreign Application Priority Data
Apr. 19, 2019 (KR) 10-2019-0046120

(51) Int. Cl. G05D 1/02; G05B 13/02; G05B 13/04; G06N 3/04; G06N 3/08; G01C 21/36; G05D 1/00

(52) U.S. Cl. CPC G05D 1/0223; G05B 13/027; G05B 13/048; G06N 3/0454; G06Q 50/30; G01C 21/36; G05D 1/0276; G05D 1/0221; G05D 1/0088; G06N 3/08

(57) ABSTRACT

A method for controlling movement of a real object by using an intelligent agent trained in a virtual environment may comprise determining an initial action value for an initial state of the real object by using an intelligent agent trained in a virtual object simulating the real object in a virtual environment; obtaining a first state as a next state of the initial state by inputting the initial action value to the real object; determining a first action value for the first state by using the intelligent agent; obtaining a second action value by correcting the first action value so that a state change of the real object coincides with a state change of the virtual object; and inputting the second action value to the real object.

### CROSS-REFERENCE TO RELATED APPLICATIONS

This application claims priority to Korean Patent Application No. 10-2019-0046120 filed on Apr. 19, 2019 in the Korean Intellectual Property Office (KIPO), the entire contents of which are hereby incorporated by reference.

### BACKGROUND

### 1. Technical Field

The present disclosure relates to a method and an apparatus for controlling movement of a real object by using an intelligent agent trained in a virtual environment, and more specifically, to a method and an apparatus for controlling movement of a real object by correcting an output of an intelligent agent trained in a virtual object of a virtual environment so as to represent the same stage change between the real object and the virtual object.

### 2. Related Art

Recently, drones, autonomous vehicles, etc. are equipped with an intelligent agent that autonomously recognizes a situation and performs appropriate determination on the recognized situation. Such the intelligent agent may be referred to as an autonomous process (or software that performs such the process) on behalf of a user for a particular purpose.

In this case, it is impossible or very difficult for a developer to consider all cases that may occur in a real environment. Therefore, there is a limit in that the developer directly specifies inference rules necessary for the intelligent agent to perform the appropriate determination for a given situation. As a means of overcoming this limitation, recent researches on intelligent agents that make appropriate determinations using neural networks have been actively conducted.

In order to use an artificial neural network for the intelligent agent, a process of training the artificial neural network should be preceded. Training the artificial neural network by operating a real object equipped with the intelligent agent may consume a lot of time and money, and may cause a big accident in the real environment. In this reason, a method of training the artificial neural network by operating a virtual object synchronized with the real object in a virtual environment has been proposed as an alternative.

When reproducing the virtual object that operates in the same manner as the real object, not only a modeling error of the virtual object but also a modeling error (e.g., a friction coefficient difference according to a road surface type) of the real environment may occur. Conventionally, modeling should be performed as precisely as possible, and modeling parameters are manually adjusted in order to correct such the errors.

However, such the conventional method requires a developer to correct an error every time the real environment changes, and even when the error is corrected, it is difficult to completely reproduce the real environment.

### SUMMARY

Accordingly, exemplary embodiments of the present disclosure provide a method for controlling movement of a real object by using an intelligent agent trained in a virtual environment.

Accordingly, exemplary embodiments of the present disclosure also provide an apparatus for controlling movement of a real object by using an intelligent agent trained in a virtual environment.

In order to achieve the objective of the present disclosure, a method for controlling movement of a real object by using an intelligent agent trained in a virtual environment may comprise determining an initial action value for an initial state of the real object by using an intelligent agent trained in a virtual object simulating the real object in a virtual environment; obtaining a first state as a next state of the initial state by inputting the initial action value to the real object; determining a first action value for the first state by using the intelligent agent; obtaining a second action value by correcting the first action value so that a state change of the real object coincides with a state change of the virtual object; and inputting the second action value to the real object.

The initial state may include at least one of a position, a direction, a speed, an altitude, and a rotation of the real object.

The obtaining of the second action value may comprise obtaining an additional action value for correcting an action error of the intelligent agent by using a pre-trained additional action prediction model; and obtaining the second action value by using the additional action value and the first action value.

The additional action prediction model may be pre-trained in the virtual object so as to predict the additional action value based on two successive states of the object and an action value that induced a successive state change of the object.

The additional action prediction model may include a forward neural network receiving the initial action value and the initial state, and predicting the next state for the initial state with respect to the virtual object; and an inverse neural network receiving the next state predicted by the forward neural network and the first state, and predicting and outputting the additional action value.

The obtaining of the first state may comprise obtaining a predicted value for the first state by inputting the initial state and the initial action value to a pre-trained state prediction model; obtaining an additional action value for correcting an initial action error of the intelligent agent by inputting the predicted value, the initial state, and the initial action value to the additional action prediction model; correcting the initial action value by using the additional action value for correcting the initial action error; and obtaining the first state by inputting the corrected initial action value to the real object.

The state prediction model may be pre-trained in the real object located in a real environment so as to predict a next state of a current state of the real object based on the current state and an action value determined by the intelligent agent in the current state.

The state prediction model may include a forward neural network receiving the initial action value and the initial state and predicting the next state for the initial state with respect to the real object.

The method may be implemented using at least one instruction, and performed by a processor included in the real object, which executes the at least one instruction.

The method may be implemented using at least one instruction, and performed by a processor included in a separate apparatus located outside of the real object, which executes the at least one instruction.

In order to achieve the objective of the present disclosure, an apparatus for controlling movement of a real object by using an intelligent agent trained in a virtual environment may comprise at least one processor; and a memory storing instructions causing the at least one processor to perform at least one step, wherein the at least one step comprises: determining an initial action value for an initial state of the real object by using an intelligent agent trained in a virtual object simulating the real object in a virtual environment; obtaining a first state as a next state of the initial state by inputting the initial action value to the real object; determining a first action value for the first state by using the intelligent agent; obtaining a second action value by correcting the first action value so that a state change of the real object coincides with a state change of the virtual object; and inputting the second action value to the real object.

The initial state may include at least one of a position, a direction, a speed, an altitude, and a rotation of the real object.

The obtaining of the second action value may comprise obtaining an additional action value for correcting an action error of the intelligent agent by using a pre-trained additional action prediction model; and obtaining the second action value by using the additional action value and the first action value.

The additional action prediction model may be pre-trained in the virtual object so as to predict the additional action value based on two successive states of the object and an action value that induced a successive state change of the object.

The additional action prediction model may include a forward neural network receiving the initial action value and the initial state, and predicting the next state for the initial state with respect to the virtual object; and an inverse neural network receiving the next state predicted by the forward neural network and the first state, and predicting and outputting the additional action value.

The obtaining of the first state may comprise obtaining a predicted value for the first state by inputting the initial state and the initial action value to a pre-trained state prediction model; obtaining an additional action value for correcting an initial action error of the intelligent agent by inputting the predicted value, the initial state, and the initial action value to the additional action prediction model; correcting the initial action value by using the additional action value for correcting the initial action error; and obtaining the first state by inputting the corrected initial action value to the real object.

The state prediction model may be pre-trained in the real object located in a real environment so as to predict a next state of a current state of the real object based on the current state and an action value determined by the intelligent agent in the current state.

The state prediction model may include a forward neural network receiving the initial action value and the initial state and predicting the next state for the initial state with respect to the real object.

The apparatus may be configured as built in or integrated with the real object.

The apparatus may be a separate apparatus located outside of the real object.

Using the method and apparatus for controlling movement of the real object using the intelligent agent trained in the virtual environment according to the exemplary embodiments of the present disclosure as described above, a difference between the movement of the real object and the virtual object can be minimized. In addition, there is an advantage that the movements of the virtual object and the real object can be autonomously synchronized even when the real environment changes.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram for describing a method and an apparatus of controlling movement of a real object by using an intelligent agent trained in a virtual environment according to an exemplary embodiment of the present disclosure;

FIG. 2 is a block diagram functionally illustrating a configuration of a virtual object according to an exemplary embodiment of the present disclosure;

FIG. 3 is a block diagram functionally illustrating a configuration of a real object according to an exemplary embodiment of the present disclosure;

FIG. 4 is a conceptual diagram for describing a method of compensating for a difference between actions of a virtual object and a real object according to an exemplary embodiment of the present disclosure;

FIG. 5 is a conceptual diagram illustrating components required to compensate for a difference between actions of a virtual object and a real object according to an exemplary embodiment of the present disclosure;

FIG. 6 is a control flowchart of a method of controlling movement of a real object using an intelligent agent trained in a virtual environment according to an exemplary embodiment of the present disclosure;

FIG. 7 is a control flowchart illustrating a means for predicting a next state with respect to an initial state in a method of controlling movement of a real object using an intelligent agent trained in a virtual environment according to an exemplary embodiment of the present disclosure;

FIG. 8 is a conceptual diagram illustrating a configuration of a means for predicting a next state with respect to an initial state in a method of controlling movement of a real object by using an intelligent agent trained in a virtual environment according to an exemplary embodiment of the present disclosure;

FIG. 9 is a flowchart illustrating a method of controlling movement of a real object by using an intelligent agent trained in a virtual environment according to an exemplary embodiment of the present disclosure;

FIG. 10 is a hardware configuration diagram of an apparatus for controlling movement of a real object by synchronizing a virtual object and the real object according to an exemplary embodiment of the present disclosure; and

FIGS. 11 to 12 are diagrams for describing application examples of a method and an apparatus for controlling movement of a real object by synchronizing a virtual object with the real object according to an exemplary embodiment of the present disclosure.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

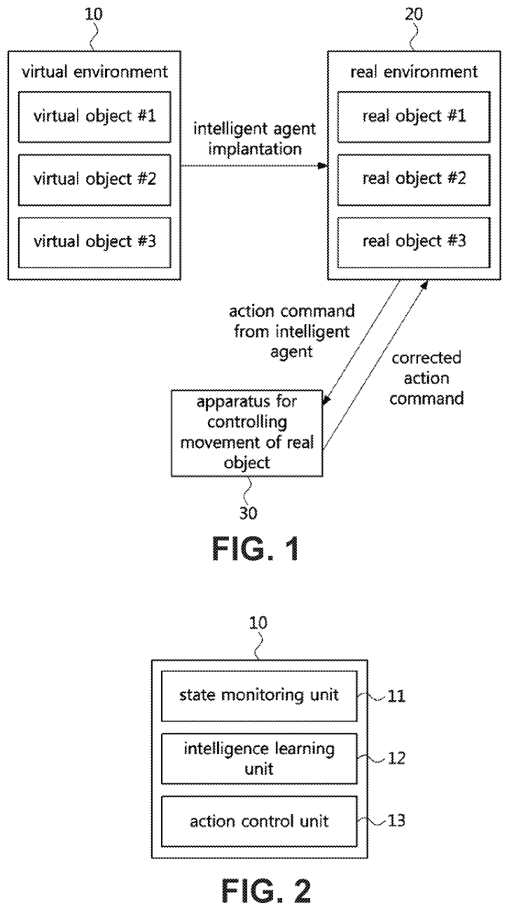

FIG. 1 is a conceptual diagram for describing a method and an apparatus of controlling movement of a real object by using an intelligent agent trained in a virtual environment according to an exemplary embodiment of the present disclosure.

The present disclosure proposes a method and an apparatus for resolving an error generated when implanting an artificial neural network trained through a virtual object located in a virtual environment into a real object, and applying the artificial neural network trained in the virtual environment to the real object as it is.

As shown in FIG. 1, the method and apparatus for controlling movement of a real object using an intelligent agent trained in a virtual environment according to an exemplary embodiment of the present disclosure may be performed through at least one virtual object 10 (e.g., virtual object #1, virtual object #2, virtual object #3) located in a virtual environment, at least one real object 20 (e.g., real object #1, real object #2, real object #3) located in a real environment, and an apparatus 30 controlling movement of the real objects 30. Hereinafter, the apparatus 30 may be referred to also as a ‘compensator’.

The virtual object 10 may be an entity generated by modeling the real object 20 in the virtual environment, and may simulate operations and states of the corresponding real object and reproduce the real object in the virtual environment. For example, in FIG. 1, the virtual object #1 may be an entity modeling the real object #1 and matched with the real object #1, the virtual object #2 may be an entity modeling the real object #2 and matched with the real object #2, and the virtual object #3 may be an entity modeling the real object #3 and matched with the real object #3. In this case, each of the virtual objects 10 may be equipped with an intelligent agent (which may be a software module for determining an action value of the object in the current state of the object through an artificial neural network) to be mounted on each of the real objects. In the virtual environment, the virtual object 10 may operate while training the intelligent agent (or, artificial neural network used by the intelligent agent).

Each of the real objects 20 may be equipped with the intelligent agent trained in the virtual environment, may autonomously perform determination on the real environment by using the mounted intelligent agent, and may operate according to the determination result. The real object may be a drone, an autonomous vehicle, a robot cleaner, or the like.

The apparatus (or, compensator) 30 for controlling movement of the real object may be an apparatus or a software module that corrects an error generated when the intelligent agent trained in the virtual environment operates in the real object 20 located in the real environment. Specifically, the apparatus (or, compensator) 30 for controlling the movement of the real object may obtain an action command of the intelligent agent implanted in the real object 20, and correct the obtained action command by adding a compensation value to the obtained action command so as to generate a corrected action command. Then, the compensator 30 may transmit the corrected action command to the real object 20.

Here, the compensation value is a value that corrects (or eliminates) an error that may occur between the action of the virtual object located in the virtual environment and the action of the real object located in the real environment, and may be a value for correcting a difference between the virtual environment that the intelligent agent learns and the real environment on which the intelligent agent should make determinations, a modeling error for the virtual object 10 and the virtual environment, and the like. In addition, the corrected action command may be an action command for inducing movement of the real object 20, but information necessary for the real object 20 to cancel or eliminate the error with the virtual object (e.g., a difference between states of the virtual object and the real object, a calculated error, or the like).

The real object 20 may perform an action based on the corrected action command received from the apparatus 30 that controls the movement of the real object 20. As such, in an exemplary embodiment of the present disclosure, instead of adjusting parameters for modeling the virtual object and controlling the state of the virtual object according to various state changes of the real object, the intelligent agent trained in the virtual object may be directly implanted into the real object. In addition, the compensator (i.e., the apparatus 30) for inputting a feedback action command to the real object may be used. In addition, although the apparatus for controlling the movement of the real object has been described as a separate apparatus from the real object, it may be embodied integrally with the real object.

According to the exemplary embodiment in FIG. 1, even when the intelligent agent trained in the virtual environment is directly implanted in the real object and used as it is, the apparatus 30 controlling the movement of the real object may calculate the compensation value and cancel the state error between the virtual object and the real object, so that a cumbersome procedure of continuously modifying and adjusting the modeling of the virtual object can be omitted.

FIG. 2 is a block diagram functionally illustrating a configuration of a virtual object according to an exemplary embodiment of the present disclosure.

Referring to FIG. 2, the virtual object 10 may include a state monitoring unit 11, an intelligence learning unit 12, and/or an action control unit 13.

Here, the state monitoring unit 11 may monitor and collect state information (e.g., temperature, position, altitude, direction, speed, rotation, etc.) of the virtual object located in the virtual environment and/or state information (e.g., temperature, humidity, wind direction, wind speed, friction, geothermal, etc. configured for the virtual environment) for the virtual environment. The state information of the virtual object and the virtual environment may be collectively referred to as ‘virtual state information’.

The intelligence learning unit 12 may receive the virtual state information collected by the state monitoring unit 11 as inputs, and output an optimal action command according to the virtual state information. For example, the intelligence learning unit 12 may include an artificial neural network, and more specifically, a convolutional neural network. Alternatively, the intelligence learning unit 12 may be the intelligent agent described with reference to FIG. 1.

The action control unit 13 may implement an action of the virtual object in the virtual environment according to the action command output from the intelligence learning unit 12.

Here, the state information may include a state change (e.g., change in temperature, position, altitude, direction, speed, rotation, etc.) of the object itself generated as the virtual object or the real object performs the action.

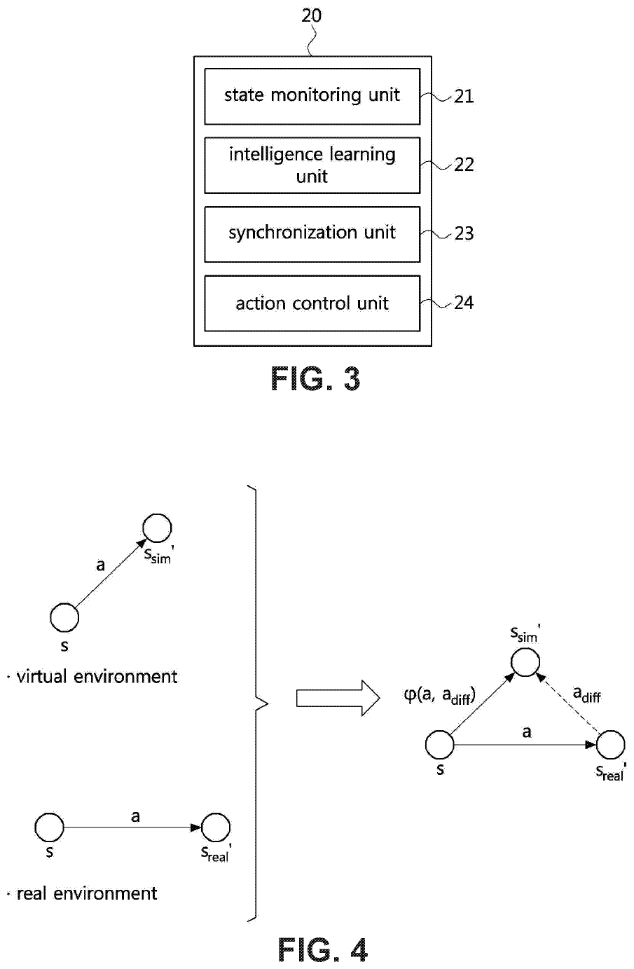

FIG. 3 is a block diagram functionally illustrating a configuration of a real object according to an exemplary embodiment of the present disclosure.

Referring to FIG. 3, the real object 20 may include a state monitoring unit 21, an intelligence learning unit 22, a synchronization unit 23, and/or an action control unit 24.

Here, the state monitoring unit 21 may monitor and collect state information (e.g., temperature, position, altitude, direction, speed, rotation, etc.) of the real object located in the real environment and/or state information (e.g., temperature, humidity, wind direction, wind speed, friction, geothermal, etc. measured in the real environment) for the real environment. The state information of the real object and the real environment may be collectively referred to as ‘real state information’.

The intelligence learning unit 22 may receive the real state information collected by the state monitoring unit 21 as inputs, and output an optimal action command according to the real state information. For example, the intelligence learning unit 22 may include an artificial neural network, and more specifically, a convolutional neural network. Alternatively, the intelligence learning unit 22 may be the artificial neural network (or, intelligent agent using the artificial neural network) which has been trained in the virtual object located in the virtual environment and implanted into the real object 20.

The synchronization unit 23 may correct the action command output from the intelligence learning unit 22 based on the corrected action command received from the external apparatus 30 for controlling the movement of the real object. That is, the synchronization unit 23 may correct the action command of the intelligence learning unit 22 by using the corrected action command provided from the external apparatus 30, so that an action result of the real object coincides with an action result of the virtual object located in the virtual environment. Here, the action result may include moving direction, moving path, moving distance, height, speed, position in space, and the like of the real or virtual object.

In addition, the synchronization unit 23 may be a functional unit in which the apparatus 30 for controlling the movement of the real object according to FIG. 1 is embedded in form of a software module. In this case, the synchronization unit 23 may generate the corrected action command by using the action value obtained from the intelligence learning unit 22 and the state information obtained from the state monitoring unit 21, and input the corrected action command to the action control unit 24.

The action control unit 24 may implement the action of the real object according to the action command of the intelligence learning unit 22, and when there is a corrected action command output from the synchronization unit 23, the action control unit 13 may preferentially perform the action according to the corrected action command output from the synchronization unit 23. For example, the action control unit 24 may be a joint, gear, motor, etc. mounted on the real object, or a device transmitting an input signal to the joint, gear, motor, etc.

FIG. 4 is a conceptual diagram for describing a method of compensating for a difference between actions of a virtual object and a real object according to an exemplary embodiment of the present disclosure.

When the current state of the virtual object located in the virtual environment is represented as ‘s’, and the virtual object performs an action according to an action value ‘a’, the next state of the virtual object may be assumed to be ‘Sₛᵢₘ′’. Also, when the current state of the real object located in the real environment is represented as ‘s’, and the real object performs an action according to the same action value ‘a’ as the virtual object, the next state of the real object may be assumed to be ‘Sᵣₑₐₗ′’. In this case, the most ideal case may be a case where the next state Sₛᵢₘ′ of the virtual object coincides with the next state Sᵣₑₐₗ′ of the real object. However, in general, when the intelligent agent trained in the virtual object is implanted into the real object and the real object is operated, a difference may occur between a state change of the virtual object and a state change of the real object. That is, when the same action value ‘a’ is input to the virtual object and the real object, the next state Sₛᵢₘ′ of the virtual object and the next state Sᵣₑₐₗ′ of the real object may be different from each other.

Therefore, in order to compensate for the movement of the real object based on the difference of states, it may be necessary to predict an additional action value ‘a_{diff}’ required for the real object to change from the next state Sᵣₑₐₗ′ of the real object to the next state Sₛᵢₘ′ of the virtual object.

In addition, the real object located in the real environment should change from the current state ‘s’ directly to the state which is the same as the next state Sₛᵢₘ′ in the virtual environment so as to ensure that the intelligent agent trained in the virtual object works correctly in the real object. Therefore, the compensator (which may be the apparatus 30 according to FIG. 1) generating a feedback action command for correcting the action value of the real object may output an action value ‘φ(a, a_{diff})’ required for the real object to change from the current state ‘s’ to the next state Sₛᵢₘ′ by using the currently-input action value ‘a’ and the additional action value ‘a_{diff}’.

That is, an exemplary embodiment of the present disclosure proposes a model for predicting the additional action value ‘a_{diff}’ required for the real object to change from the next state Sᵣₑₐₗ′ of the real object to the next state Sₛᵢₘ′ of the virtual object and a compensator for calculating the action value ‘φ(a, a_{diff})’ required for the real object to change from the current state ‘s’ to the same state as the next state Sₛᵢₘ′ of the virtual object.

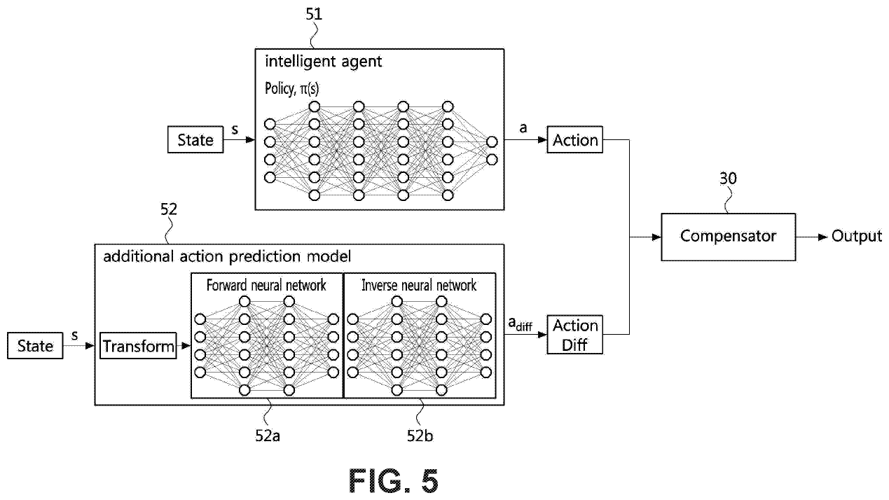

FIG. 5 is a conceptual diagram illustrating components required to compensate for a difference between actions of a virtual object and a real object according to an exemplary embodiment of the present disclosure.

First, an intelligent agent 51 may be a first component for ensuring that the intelligent agent trained in the virtual object operates identically in the real object. The intelligent agent 51 may determine an optimal action ‘a’ that the object should perform in the current state ‘s’ given to the object. In this case, as described above, the intelligent agent 51 may be mounted in the virtual object and pre-trained in the virtual environment, and the trained intelligent agent 51 may be implanted in the real object that matches the virtual object.

As a next component, there is an additional action prediction model 52 for predicting the additional action value ‘a_{diff}’ from the given current state of the object. Here, the additional action value may be an action value required for the object to change from the next state Sᵣₑₐₗ′ of the real object to the next state Sₛᵢₘ′ of the virtual object in order to correct a difference between the next states Sᵣₑₐₗ′ and Sₛᵢₘ′ generated when the same action value is applied to the real object and the virtual object, as described with reference to FIG. 4. In this case, the additional action prediction model 52 may include a forward neural network 52a and an inverse neural network 52b.

The forward artificial neural network 52a may also be referred to as ‘forward dynamics’, and the inverse artificial neural network 52b may be referred to as ‘inverse dynamics’.

Here, the forward artificial neural network 52a may be an artificial neural network that predicts the next state Sₛᵢₘ′ generated when the action value ‘a’ is input to the current state ‘s’ of the object in the virtual environment. Therefore, the forward artificial neural network 52a may receive the current state ‘s’ of the object and the action value ‘a’, and output the next state Sₛᵢₘ′ in the virtual environment. The inverse artificial neural network 52b may be an artificial neural network for receiving the next state Sₛᵢₘ′ in the virtual environment and the next state Sᵣₑₐₗ′ generated when the same action value ‘a’ as the virtual environment is input to the real environment, and predicting the additional action value ‘a_{diff}’ for correcting the difference between the next states of the real environment and the virtual environment. In this case, the value predicted and output from the forward artificial neural network 52a may be used as the next state in the virtual environment input to the inverse artificial neural network 52b. That is, the output of the forward artificial neural network 52a may be input to the inverse artificial neural network 52b.

Here, the additional action prediction model 52 may be mounted on the virtual object located in the virtual environment, and then used to predict the additional action after the forward artificial neural network 52a and the inverse artificial neural network 52b are trained. The additional action prediction model 52 may hereinafter be referred to as ‘virtual-world dynamics model’ in the sense of being trained in the virtual environment. In addition, the additional action prediction model 52 may transform the current state ‘s’ of the object into an input format usable in the artificial neural network, and receive the transformed current state (more specifically, the current state may be transformed into an input format for the forward artificial neural network).

The action value ‘a’ determined by the intelligent agent 51 and the additional action value ‘a_{diff}’ predicted by the additional action prediction model 52 may be delivered to the compensator, and the compensator may use the received action value ‘a’ and the additional action value ‘a_{diff}’ to calculate the action value ‘φ(a, a_{diff})’ required for the real object to change from the current state ‘s’ to the next state Sₛᵢₘ′ of the virtual object. Here, the action value calculated by the compensator may be input as a feedback action command for the real object. That is, the real object may perform an action control (e.g., for joint, gear, motor, etc.) according to the action value calculated by the compensator when the feedback action command is input.

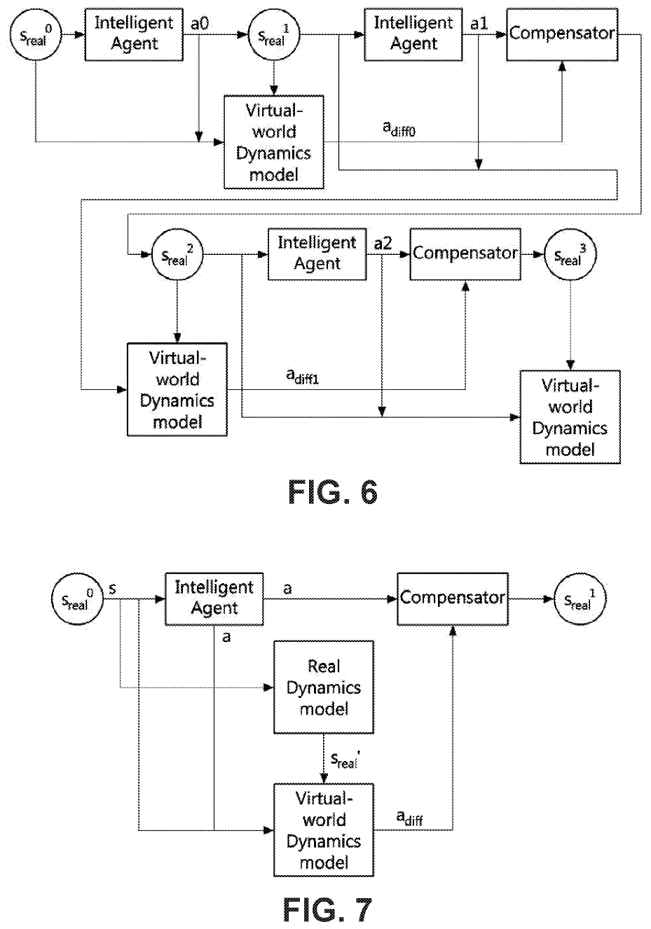

FIG. 6 is a control flowchart of a method of controlling movement of a real object using an intelligent agent trained in a virtual environment according to an exemplary embodiment of the present disclosure.

Referring to FIG. 6, first, the intelligent agent may determine an appropriate initial action value ‘a0’ based on an initial state Sᵣₑₐₗ⁰ of the real object located in the real environment, and the real object may reach a first state Sᵣₑₐₗ¹ according to the determined action value. In this case, the intelligent agent may be configured to include an artificial neural network trained in advance in the virtual environment by using the virtual object that always matches the real object.

When the real object reaches the first state Sᵣₑₐₗ¹, the intelligent agent may determine and output an appropriate first action value ‘a1’ based on the first state Sᵣₑₐₗ¹ again. In addition, the first state Sᵣₑₐₗ¹, the initial state Sᵣₑₐₗ⁰, and the initial action value ‘a0’ may be input to the additional action prediction model (or, virtual world dynamics model). The additional action prediction model may output an initial additional action value ‘a_{diff0}’ for correcting an action error of the intelligent agent trained in the virtual environment. In this case, the additional action prediction model may be used after being previously mounted and trained in the virtual object in the virtual environment.

The compensator may receive the first action value ‘a1’ output from the intelligent agent and the initial additional action value ‘a_{diff0}’ output from the additional action prediction model, and may output the action value ‘φ(a1, a_{diff0})’ required for the real object to change identically to the state change in the virtual environment. If the real object operates according to the action value ‘φ(a1, a_{diff0})’ output by the compensator, the real object may reach a second state Sᵣₑₐₗ².

When the real object reaches the second state Sᵣₑₐₗ², the intelligent agent may determine an action value ‘a2’ and the compensator may correct the determined action value ‘a2’, thereby reaching a third state Sᵣₑₐₗ³. Also in this case, the additional action value ‘a_{diff1}’ output from the additional action prediction model may be used as an input to the compensator. This process may be repeatedly performed for each process in which the real object operates to the next state.

The intelligent agent, additional action prediction model, and the compensator described with reference to FIGS. 5 and 6 may be mounted on the real object as a software module (or, instructions executed by a processor). Alternatively, they may be implemented in a manner that they are mounted and driven on an external apparatus separate from the real object, and the output of the compensator may be delivered to the real object.

Meanwhile, as can be seen in FIG. 6, the additional action prediction model may predict the additional action value when receiving a specific state and a next state of the specific state. That is, since when the real object is in the initial state Sᵣₑₐₗ⁰, the next state Sᵣₑₐₗ¹ of the real object cannot be known in advance, there is a problem that the action value ‘a0’ of the intelligent agent cannot be corrected through the compensator and a time lag occurs during a time to transition from the initial state to the next state when an interval between actions is long.

Therefore, the following describes a method of preventing a time lag by providing a means for predicting the next state of the real object in advance.

FIG. 7 is a control flowchart illustrating a means for predicting a next state with respect to an initial state in a method of controlling movement of a real object using an intelligent agent trained in a virtual environment according to an exemplary embodiment of the present disclosure.

In FIG. 6, since the next state cannot be acquired in advance in the initial state of the real object, there is a possibility that a time lag may occur when an interval between action executions is long. As a means for solving this problem, a state prediction model for predicting the next state of the real object may be further used.

Specifically, referring to FIG. 7, based on the initial state Sᵣₑₐₗ⁰ of the real object, the intelligent agent may output an action value ‘a’ appropriate for the real object to perform.

In addition, unlike FIG. 6, in FIG. 7, the state prediction model (denoted as ‘real dynamics model’) may predict and output the next state Sᵣₑₐₗ¹ of the real object based on the initial state Sᵣₑₐₗ⁰. In this case, since the state prediction model is a model for predicting the next state in the real environment, it may be referred to and denoted as ‘real dynamics model’.

The additional action prediction model (denoted as ‘virtual dynamics model’) may receive the current state of the real object, the next state predicted from the state prediction model, and the action value output from the intelligent agent, and output the additional action value ‘a_{diff}’ for correcting the action error of the intelligent agent trained in the virtual environment.

The compensator may output the action value ‘φ(a, a_{diff})’ for the real object to change identically to the state change in the virtual environment using the additional action value output from the additional action prediction model and the action value output from the intelligent agent. When the real object operates according to the action value ‘φ(a, a_{diff})’ output by the compensator, the real object may reach the first state Sᵣₑₐₗ¹.

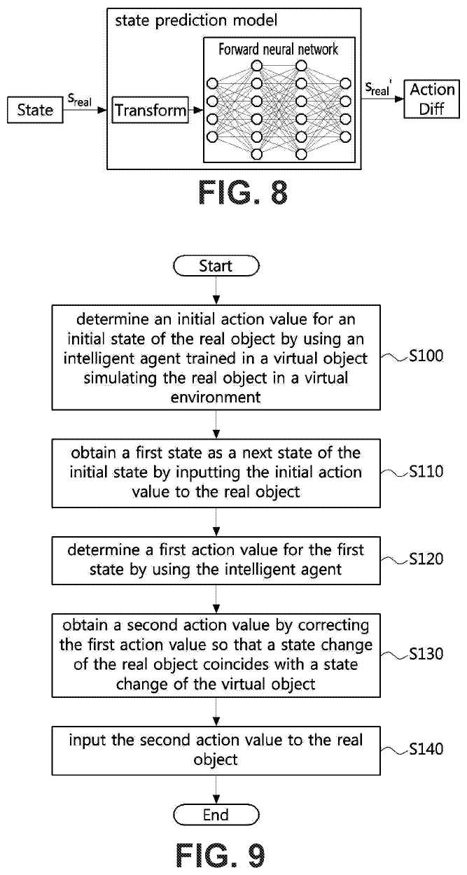

FIG. 8 is a conceptual diagram illustrating a configuration of a means for predicting a next state with respect to an initial state in a method of controlling movement of a real object by using an intelligent agent trained in a virtual environment according to an exemplary embodiment of the present disclosure.

Referring to FIG. 8, the configuration of the state prediction model described with reference to FIG. 7 may be identified.

Specifically, the state prediction model according to an exemplary embodiment of the present disclosure may include a forward artificial neural network described with reference to FIG. 5. Here, the forward artificial neural network may be an artificial neural network that receives the current state ‘s’ and the action value ‘a’ of the real object located in the real environment and predicts and outputs the next state Sᵣₑₐₗ′ of the real object. That is, the forward artificial neural network described with reference to FIG. 5 may predict the next state of the virtual object located in the virtual environment, while the forward artificial neural network according to FIG. 8 may predict the next state of the real object located in the real environment.

Therefore, the forward artificial neural network (or state prediction model) according to FIG. 8 may be mounted on the real object located in the real environment and pre-trained before use.

In addition, as in the additional action prediction model of FIG. 5, the current state ‘s’ input to the forward artificial neural network (or the state prediction model) may be transformed into an input format for the artificial neural network, and then input to the forward artificial neural network.

Meanwhile, as the artificial neural network used in the intelligent agent according to FIG. 5, the additional action prediction model, and the state prediction model according to FIG. 8, various deep learning based neural networks including VGG, ResNet, ResNext, Mobilenet, etc. may be used. In addition, the intelligent agent, the additional action prediction model, and the state prediction model may not necessarily need to use the artificial neural network, and may be a function that can predict or estimate a desired output value for a given input. In this case, the function may be a function determined through experimental approximation or may be a function determined by a mathematical or statistical technique.

FIG. 9 is a flowchart illustrating a method of controlling movement of a real object by using an intelligent agent trained in a virtual environment according to an exemplary embodiment of the present disclosure.

Referring to FIG. 9, the method for controlling movement of a real object by using an intelligent agent trained in a virtual environment may comprise a step S100 of determining an initial action value for an initial state of the real object by using an intelligent agent trained in a virtual object simulating the real object in a virtual environment; a step S110 of obtaining a first state as a next state of the initial state by inputting the initial action value to the real object; a step S120 of determining a first action value for the first state by using the intelligent agent; a step S130 of obtaining a second action value by correcting the first action value so that a state change of the real object coincides with a state change of the virtual object; and a step S140 of inputting the second action value to the real object.

The initial state may include at least one of a position, a direction, a speed, an altitude, and a rotation of the real object.

The step S130 of obtaining of the second action value may comprises obtaining an additional action value for correcting an action error of the intelligent agent by using a pre-trained additional action prediction model; and obtaining the second action value by using the additional action value and the first action value.

The additional action prediction model may be pre-trained in the virtual object so as to predict the additional action value based on two successive states of the object and an action value that induced a successive state change of the object.

The additional action prediction model may include a forward neural network receiving the initial action value and the initial state, and predicting the next state for the initial state with respect to the virtual object; and an inverse neural network receiving the next state predicted by the forward neural network and the first state, and predicting and outputting the additional action value.

The step S110 of obtaining of the first state may comprises obtaining a predicted value for the first state by inputting the initial state and the initial action value to a pre-trained state prediction model; obtaining an additional action value for correcting an initial action error of the intelligent agent by inputting the predicted value, the initial state, and the initial action value to the additional action prediction model; correcting the initial action value by using the additional action value for correcting the initial operation error; and obtaining the first state by inputting the corrected initial action value to the real object.

The state prediction model may be pre-trained in the real object located in a real environment so as to predict a next state of a current state of the real object based on the current state and an action value determined by the intelligent agent in the current state.

The state prediction model may include a forward neural network receiving the initial action value and the initial state and predicting a next state for the initial state with respect to the real object.

The method may be implemented using at least one instruction, and performed by a processor included in the real object, which executes the at least one instruction.

The method may be implemented using at least one instruction, and performed by a processor included in a separate apparatus located outside of the real object, which executes the at least one instruction.

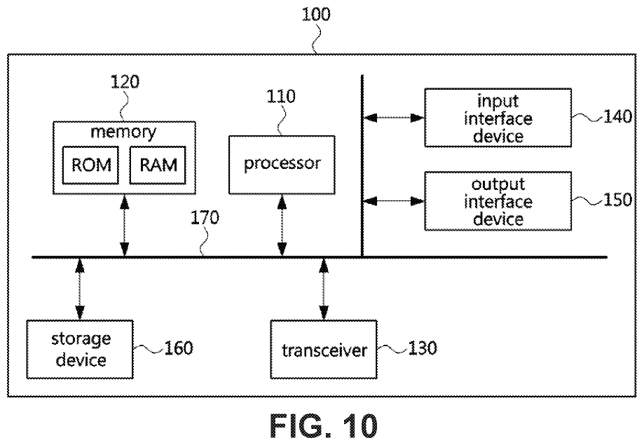

FIG. 10 is a hardware configuration diagram of an apparatus for controlling movement of a real object by synchronizing a virtual object and the real object according to an exemplary embodiment of the present disclosure.

Referring to FIG. 10, an apparatus 100 for controlling movement of a real object using an intelligent agent trained in a virtual environment may include at least one processor 110 and a memory 120 for storing instructions instructing the at least one processor 110 to perform at least one step.

In addition, the apparatus 100 may further comprise a transceiver 130 performing communications with a base station or a counterpart apparatus via wired or wireless networks. In addition, the apparatus 100 may further include an input interface device 140, an output interface device 150, a storage device 160, and the like. The components included in the apparatus 100 may be connected by a bus 170 to communicate with each other.

Here, the processor 110 may refer to a central processing unit (CPU), a graphics processing unit (GPU), or a dedicated processor on which the methods according to the exemplary embodiments of the present disclosure are performed. Each of the memory 120 and the storage device 160 may be configured as at least one of a volatile storage medium and a nonvolatile storage medium. For example, the memory 120 may be configured with at least one of a read only memory (ROM) and a random access memory (RAM).

The at least one step may comprise determining an initial action value for an initial state of the real object by using an intelligent agent trained in a virtual object simulating the real object in a virtual environment; obtaining a first state as a next state of the initial state by inputting the initial action value to the real object; determining a first action value for the first state by using the intelligent agent; obtaining a second action value by correcting the first action value so that a state change of the real object coincides with a state change of the virtual object; and inputting the second action value to the real object.

The initial state may include at least one of a position, a direction, a speed, an altitude, and a rotation of the real object.

The step of obtaining of the second action value may comprises obtaining an additional action value for correcting an action error of the intelligent agent by using a pre-trained additional action prediction model; and obtaining the second action value by using the additional action value and the first action value.

The additional action prediction model may be pre-trained in the virtual object so as to predict the additional action value based on two successive states of the object and an action value that induced a successive state change of the object.

The additional action prediction model may include a forward neural network receiving the initial action value and the initial state, and predicting the next state for the initial state with respect to the virtual object; and an inverse neural network receiving the next state predicted by the forward neural network and the first state, and predicting and outputting the additional action value.

The step of obtaining of the first state may comprises obtaining a predicted value for the first state by inputting the initial state and the initial action value to a pre-trained state prediction model; obtaining an additional action value for correcting an initial action error of the intelligent agent by inputting the predicted value, the initial state, and the initial action value to the additional action prediction model; correcting the initial action value by using the additional action value for correcting the initial operation error; and obtaining the first state by inputting the corrected initial action value to the real object.

The state prediction model may be pre-trained in the real object located in a real environment so as to predict a next state of a current state of the real object based on the current state and an action value determined by the intelligent agent in the current state.

The state prediction model may include a forward neural network receiving the initial action value and the initial state and predicting a next state for the initial state with respect to the real object.

The apparatus 100 may be built in or integrated with the real object.

The apparatus 100 may be a separate apparatus located outside of the real object.

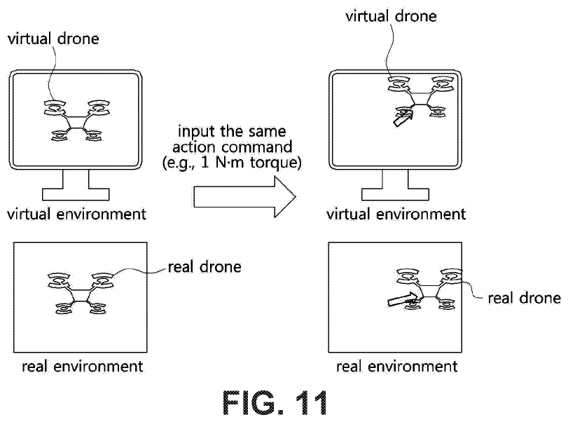

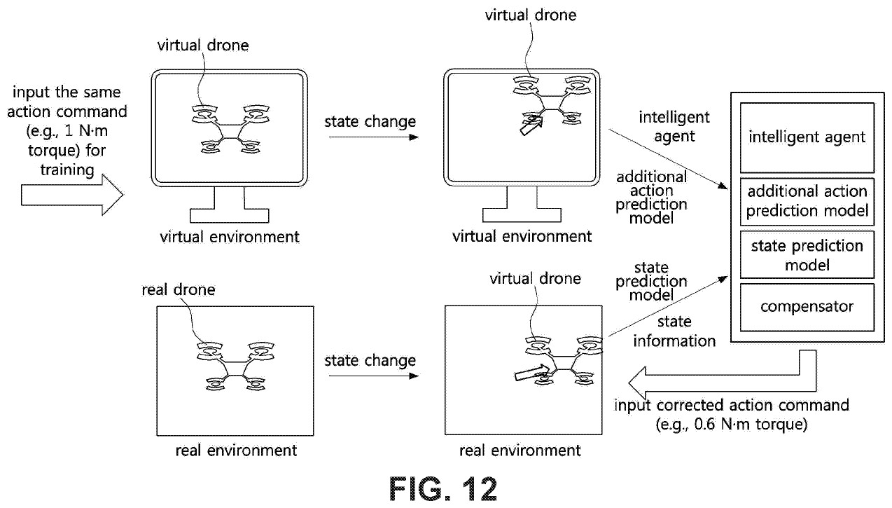

FIGS. 11 to 12 are diagrams for describing application examples of a method and an apparatus for controlling movement of a real object by synchronizing a virtual object with the real object according to an exemplary embodiment of the present disclosure.

Referring to FIGS. 11 to 12, examples in which a method and an apparatus according to an exemplary embodiment of the present disclosure are applied to a case where a real object is a drone are shown.

First, referring to FIG. 11, an action command giving a torque of 1 N·m may be input to propellers of a real drone and a virtual drone implemented in a virtual environment. However, even when the same action command is input to the virtual drone and the real drone, a state difference may occur due to limitations such as a modeling error. For example, the altitude and distance traveled by the real drone may be different from the altitude and distance traveled by the virtual drone. Such the difference may be caused by wind, geothermal heat, and the like that exist in the real environment. As such, the real environment may change over time, making it impossible to fully model the real environment in the virtual environment.

However, when the method and the apparatus according to the exemplary embodiment of the present disclosure are applied, the real object may be adjusted to cause the same state change as the virtual object, and thus the states of the virtual object and the real object may be synchronized without continuously adjusting the modeling parameters.

That is, referring to FIG. 12, the apparatus for controlling movement of the real object by synchronizing the virtual object with the real object according to an exemplary embodiment of the present disclosure may train the change of state information for the same action command in the virtual environment and the real environment, respectively. Accordingly, the intelligent agent, the additional action prediction model, the state prediction model, the compensator, etc. may be configured, and a corrected action command according to the state information of the real object may be input using the configured components. For example, a corrected action command corresponding to a torque of 0.6 N·m instead of 1 N·m may be input to the real drone, so that the real drone can reach the same state (altitude, height, direction, rotation, etc.) as the virtual drone to which the action command corresponding to the torque of 1 N·m is given.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the exemplary embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. A method for controlling movement of a real object by using an intelligent agent trained in a virtual environment, the method comprising:
determining an initial action value for an initial state of the real object by using an intelligent agent trained in a virtual object simulating the real object in a virtual environment;
obtaining a first state as a next state of the initial state by inputting the initial action value to the real object;
determining a first action value for the first state by using the intelligent agent;
obtaining a second action value by correcting the first action value so that a state change of the real object coincides with a state change of the virtual object; and
inputting the second action value to the real object.

2. The method according to claim 1, wherein the initial state includes at least one of a position, a direction, a speed, an altitude, and a rotation of the real object.

3. The method according to claim 1, wherein the obtaining of the second action value comprises:
obtaining an additional action value for correcting an action error of the intelligent agent by using a pre-trained additional action prediction model; and
obtaining the second action value by using the additional action value and the first action value.

4. The method according to claim 3, wherein the additional action prediction model is pre-trained in the virtual object so as to predict the additional action value based on two successive states of the object and an action value that induced a successive state change of the object.

5. The method according to claim 4, wherein the additional action prediction model includes:
a forward neural network receiving the initial action value and the initial state, and predicting the next state for the initial state with respect to the virtual object; and
an inverse neural network receiving the next state predicted by the forward neural network and the first state, and predicting and outputting the additional action value.

6. The method according to claim 4, wherein the obtaining of the first state comprises:
obtaining a predicted value for the first state by inputting the initial state and the initial action value to a pre-trained state prediction model;
obtaining an additional action value for correcting an initial action error of the intelligent agent by inputting the predicted value, the initial state, and the initial action value to the additional action prediction model;
correcting the initial action value by using the additional action value for correcting the initial action error; and
obtaining the first state by inputting the corrected initial action value to the real object.

7. The method according to claim 6, wherein the state prediction model is pre-trained in the real object located in a real environment so as to predict a next state of a current state of the real object based on the current state and an action value determined by the intelligent agent in the current state.

8. The method according to claim 7, wherein the state prediction model includes a forward neural network receiving the initial action value and the initial state and predicting the next state for the initial state with respect to the real object.

9. The method according to claim 1, wherein the method is implemented using at least one instruction, and performed by a processor included in the real object, which executes the at least one instruction.

10. The method according to claim 1, wherein the method is implemented using at least one instruction, and performed by a processor included in a separate apparatus located outside of the real object, which executes the at least one instruction.

11. An apparatus for controlling movement of a real object by using an intelligent agent trained in a virtual environment, the apparatus comprising:
at least one processor; and
a memory storing instructions causing the at least one processor to perform at least one step,
wherein the at least one step comprises:
determining an initial action value for an initial state of the real object by using an intelligent agent trained in a virtual object simulating the real object in a virtual environment;
obtaining a first state as a next state of the initial state by inputting the initial action value to the real object;
determining a first action value for the first state by using the intelligent agent;
obtaining a second action value by correcting the first action value so that a state change of the real object coincides with a state change of the virtual object; and
inputting the second action value to the real object.

12. The apparatus according to claim 11, wherein the initial state includes at least one of a position, a direction, a speed, an altitude, and a rotation of the real object.

13. The apparatus according to claim 11, wherein the obtaining of the second action value comprises:
obtaining an additional action value for correcting an action error of the intelligent agent by using a pre-trained additional action prediction model; and
obtaining the second action value by using the additional action value and the first action value.

14. The apparatus according to claim 13, wherein the additional action prediction model is pre-trained in the virtual object so as to predict the additional action value based on two successive states of the object and an action value that induced a successive state change of the object.

15. The apparatus according to claim 14, wherein the additional action prediction model includes:
a forward neural network receiving the initial action value and the initial state, and predicting the next state for the initial state with respect to the virtual object; and
an inverse neural network receiving the next state predicted by the forward neural network and the first state, and predicting and outputting the additional action value.

16. The apparatus according to claim 14, wherein the obtaining of the first state comprises:
obtaining a predicted value for the first state by inputting the initial state and the initial action value to a pre-trained state prediction model;
obtaining an additional action value for correcting an initial action error of the intelligent agent by inputting the predicted value, the initial state, and the initial action value to the additional action prediction model;
correcting the initial action value by using the additional action value for correcting the initial action error; and
obtaining the first state by inputting the corrected initial action value to the real object.

17. The apparatus according to claim 16, wherein the state prediction model is pre-trained in the real object located in a real environment so as to predict a next state of a current state of the real object based on the current state and an action value determined by the intelligent agent in the current state.

18. The apparatus according to claim 17, wherein the state prediction model includes a forward neural network receiving the initial action value and the initial state and predicting the next state for the initial state with respect to the real object.

19. The apparatus according to claim 11, wherein the apparatus is built in or integrated with the real object.

20. The apparatus according to claim 11, wherein the apparatus is a separate apparatus located outside of the real object.
